(19) United States
(12) Patent Application Publication
(10) Pub. No.: US 2003/0093651 A1
(43) Pub. Date: May 15, 2003

(54) Instruction sets and compilers

(76) Inventor: Shinichiro Kobayashi, Tokyo (JP)

Correspondence Address: HOGAN & HARTSON L.L.P., 500 S. GRAND AVENUE, SUITE 1900, LOS ANGELES, CA, 90071-2611, US

(21) Appl. No.: 10/285,370

(22) Filed: Oct. 31, 2002

(30) Foreign Application Priority Data
Oct. 31, 2001 (JP) 2001-334616

(51) Int. Cl. G06F 9/45

(52) U.S. Cl. 712/209; 712/227; 717/136

(57) ABSTRACT

Instruction sets are provided in which it is possible to store offsets until a depended instruction is reached, in addition to own command codes and operands, in a part of instructions. Commands can be recombined in response to the state of resources within a CPU on the basis of this information on the CPU side. Compilers are also provided. When the compilers generate an execution code, an offset showing dependency of instruction is entered at a prescribed position, and is used as a command code. As a result, the dependency can easily be determined on the CPU side, and the CPU can provide optimum processing capability in response to the use of the resources of the CPU varying from time to time.

### BACKGROUND OF THE INVENTION

The present invention relates to instruction sets and compilers, and more particularly, to instruction sets and compilers that can provide improvements in system operating rates.

An instruction is a set of primarily specified binary signals for individual CPUs, including operation codes indicating purposes of execution, and operands clearly specifying objects of operation of such operation codes. Information about preparations for the next commands are also present in these instructions.

Commonly known types of instruction sets include a type in which a plurality of operations are indicated within a CPU by a single instruction, known as Complex Instruction Set Computer (CISC), and a type in which a single instruction corresponds to only a single operation within a CPU, known as Reduced Instruction Set Computer (RISC).

In a CPU or the like having a pipeline configuration, it is desirable to improve the efficiency of which resources in a CPU are utilized. It is also desirable to improve the performance of the entire unit by reading out the above-mentioned instruction from a memory, executing a specified processing on the basis thereof, writing the result into the memory, and repeating these steps.

Usually instructions such as register-register transfer, pushing a register value to a stack, and popping from the stack, a typical problem that is encountered is a delay time of the register in terms of the rate of the pipeline. The system operating rate can be improved by reducing propagation delay time of the register.

However, improvement of the system operating rate can cause other problems. The very large propagation delay times, associated with the arithmetic circuits used to perform various arithmetic operations, can lead to difficulties. For example, it may be difficult for the system clock cycle to absorb the delay in the circuits executing processing. The user therefore often reduces an apparent amount of delay between pipelines by increasing the number of stages of the pipelines.

Directly reducing the system operating rate can decrease performance. Increasing the number of stages of pipelines, on the other hand, results in a decrease in the throughput per command, and leads to an increase in the hardware cost.

Accordingly, there is a need for instruction sets and compilers that can provide improvements in system operating rates, without increasing the number of stages of pipelines.

### SUMMARY OF THE PREFERRED EMBODIMENTS

An aspect of the present invention provides instruction sets in which it is possible to store offsets until a depended instruction is reached, in addition to own command codes and operands, in a part of instructions. The offset can be caused by a difference in bits and a difference in the sequence of commands from the depended instruction. Commands can be recombined in response to the state of resources within a CPU on the basis of this information on the CPU side.

Another aspect of the present invention provides compilers. When the compiler generates an execution code, an offset showing dependency of instruction is entered at a prescribed position, and is used as a command code. When all the offset values have a bit of 0, there is not dependency, and when the lowest bit of the offset values is 1, the immediately preceding instruction can be depended upon.

Related systems and methods are also provided.

### BRIEF DESCRIPTION OF DRAWINGS

FIG. 1 illustrates the instruction set and the compiler of an embodiment of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

When generating an instruction an operation known as scheduling is conventionally carried out. Scheduling can be defined as extracting dependency by means of a compiler or the like, and recombining the sequence of execution. After scheduling, the CPU is not notified of the current information. Thus, in conventional systems interpreting dependency of instructions was very costly due to the considerable amount of hardware required for extracting the dependency of instructions on the CPU side.

Aspects of the present invention can provide instruction sets and compilers that can provide improvements in system operating rates, without increasing the number of pipeline stages. This can prevent increased hardware costs. As a result, the CPU can provide optimum processing capability when the use of the CPU resources varies.

Practice of preferred aspects of the present invention can provide instruction sets in which it is possible to store offsets until a depended instruction is reached, in addition to own command codes and operands, in a part of instructions. The offset can be caused by a difference in bits and/or a difference in the sequence of commands from the depended instruction. Commands can be recombined in response to the state of resources within a CPU based on information on the CPU side.

Practice of preferred aspects of the present invention can also provide compilers. When the compiler generates an execution code, an offset showing dependency of instruction is entered at a prescribed position. This offset is used as a command code. When all the offset values have a bit of 0, there is not dependency, and when the lowest bit of the offset values is 1, the immediately preceding instruction can be depended upon. As a result, the dependency can easily be determined on the CPU side. On the compiler side, it suffices to conduct scheduling as is conventional. As a result, the CPU can provide optimum processing capability in response to the use of the CPU resources varying from time to time.

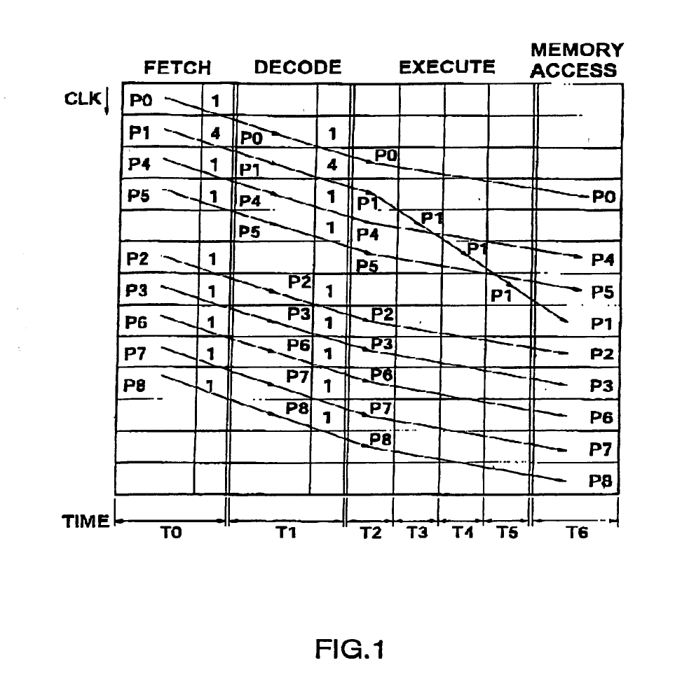

Embodiments of the present invention will now be described with reference to FIG. 1 which illustrates one of the many possible embodiments of an instruction set and compiler implementing at least some aspects of the invention. FIG. 1 shows a processing image in a passing-type pipeline. A fetch state, decode state, execute state (four-stage pipeline), and memory access state are shown sequentially from left to right, and details of processing are shown for each clock (CLK) sequentially from top to bottom.

As shown in FIG. 1, in the instruction set of the invention, it is made possible to store offsets until a depended instruction is reached, in addition to own command codes and operands, in a part of instructions. Commands are recombined in response to the state of resources within a CPU based on information on the CPU side.

When the compiler generates an execution code, an offset showing dependency of instruction is entered at a prescribed position. This offset is used as a command code. For example, it can be assumed that, when all the offset values have a bit of 0, there is no dependency, and that when the lowest bit of the all of the offset values is 1, the immediately preceding instruction is depended upon.

In this embodiment, instructions P2 and P3 are assumed to be dependent upon an instruction P1. The distance between the instructions P2 and P3 and the instruction P1, in front of the instructions P2 and P3, (i.e., offset information) is added to the instructions P2 and P3.

Fetch and decode of the instruction P0 are executed by use of a single-stage pipeline and memory access processing is carried out.

On the other hand, fetch operation of the instruction P0 is followed by the fetch operation of the instruction P1. Subsequently, decode, execute and memory access processes of the instruction P1 are carried out. In this case, the instruction P1 is executed by means of a four-stage pipeline.

The fetch operation of the instruction P1 should normally be followed by the fetch operation of the instruction P2. However, because the instruction P2 depends upon the instruction P1, offset information of the instruction P2 is confirmed. Since the instruction P2 is executed by means of only a single-stage pipeline, the fetch operation is carried out with a delay of at least three clocks from the fetch operation of the instruction P1 so that memory access can be conducted after the instruction P1 upon which the instruction P2 depends.

The fetch operation of the instruction P1 should be followed sequentially by the fetch operations of the instructions P4 and P5. Instructions P4 and P5 have no dependency upon the instruction P1. Instructions P4 and P5 are each executed by means of a single-stage pipeline. Memory access for these instructions P4 and P5 is therefore accomplished before the instruction P1.

Circuits in the execute portion, such as an arithmetic operation circuit, should be free from any change in input until affirmation of output. A simplified type input retaining circuit is provided in this input portion.

The fetch operation of the instruction P2 is started upon the lapse of one clock after the fetch operation of the instruction P5. Thereafter, decode, execute and memory access processes of the instruction P2 are carried out. Because the instruction P2 is executed by use of a single-stage pipeline, memory access is performed immediately after the instruction P1.

The fetch operation of the instruction P2 is followed by fetch, decode, execute and memory access processes of the instruction P3.

After the fetch operation of the instruction P3, the instructions P6, P7 and P8 which are not in a dependency relationship are successively conducted.

Thus, instruction sets and compilers are provided that can provide improvements in system operating rates, without increasing the number of pipeline stages. This can prevent increased hardware costs. As a result, the CPU can provide optimum processing capability when the use of the CPU resources varies.

While aspects of the present invention have been described in terms of certain preferred embodiments, those of ordinary skill in the will appreciate that certain variations, extensions and modifications may be made without varying from the basic teachings of the present invention. As such, aspects of the present invention are not to be limited to the specific preferred embodiments described herein. Rather, the scope of the present invention is to be determined from the claims, which follow.

What is claimed is:

1. An instruction set, wherein:
it is made possible to store offsets until a depended instruction is reached, in addition to own command codes and operands, in a part of instructions; and
commands are recombined in response to the state of resources within a central processing unit (CPU) on the basis of this information on the CPU side.

2. An instruction set according to claim 1, wherein said offset is caused by a difference in bits and a difference in the sequence of commands from the depended instruction.

3. A compiler, wherein, when generating an execution code, an offset showing dependency of instruction is entered at a prescribed position, and is used as a command code.

4. A compiler according to claim 3, wherein:
when all said offset values have a bit of 0, there is no dependency; and
when the lowest bit of said offset values is 1, the immediately preceding instruction is depended upon.

5. An instruction set for use with a central processing unit (CPU), comprising:
a plurality of instructions, wherein at least one instruction includes, command codes, operands, an offset, and a depended instruction, wherein the offset, command codes, and operands are stored until the depended instruction is reached; and
a plurality of commands, wherein the commands are recombined in response to a state of resources within the CPU on the basis of the instructions on the CPU side.

6. An instruction set according to claim 5, wherein said offset is caused by a difference in bits and a difference in the sequence of commands from the depended instruction.

7. A compiler, comprising:
means for generating an execution code,
wherein an offset showing dependency of instruction is entered at a prescribed position and is used as a command code, when generating the execution code.

8. A compiler according to claim 7, wherein:
when all said offset values have a bit of 0, there is no dependency; and
when the lowest bit of said offset values is 1, the immediately preceding instruction is depended upon.

9. An instruction set for use in a central processing unit (CPU), comprising:
a first instruction;
a second instruction dependent upon the first instruction, wherein offset information is added to the second instruction, wherein the offset information specifies the distance between the second instruction and the first instruction; and
a third instruction dependent upon the first instruction; wherein offset information is added to the third instruction, wherein the offset information specifies the distance between the third instruction and the first instruction.

10. The instruction set according to claim 9, wherein the second and third instructions follow the first instruction.

11. A system, comprising:
a central processing unit (CPU) side including a CPU;
a compiler for entering an external program into the CPU when processing the external program in the CPU;
an instruction set, wherein a depended instruction is embedded in the instruction set, wherein offsets are stored until the depended instruction is reached.

12. The system of claim 11, wherein, in response to the state of resources within the CPU, commands are recombined on the basis of the instruction set on the CPU side.

13. The system of claim 11, wherein the compiler comprises:
means for generating an execution code; and
means for entering offset values at a prescribed positions, the offset showing dependency of instruction, wherein the offset is used as a command code.

14. The system of claim 13, wherein, when all the offset values have a first value, there is not dependency.

15. The system of claim 13, wherein, when the lowest bit of the offset values is a second value, the immediately preceding instruction is depended upon.

16. The system of claim 11, wherein the CPU side further comprises:
means for extracting the dependency of instructions on the CPU side such that the dependency can be determined on the CPU side.

17. The system of claim 11, wherein the compiler comprises:
means for generating an instruction;
means for extracting dependency; and
means for recombining the sequence of execution.

18. A method of compiling an instruction set that includes an initial instruction, a first instruction, a second instruction that depends upon the first instruction, wherein the second instruction includes offset information, a third instruction, a fourth instruction having no dependency upon the first instruction, and a fifth instruction having no dependency upon the first instruction, the method comprising:
fetching the initial instruction;
decoding the initial instruction;
executing the initial instruction by use of a single-stage pipeline;
accessing memory;
fetching the first instruction;
decoding the first instruction;
executing the first instruction by use of four-stage pipelines; and
confirming offset information of the second instruction.

19. A method according to claim 18, further comprising:
fetching the fourth instruction;
fetching the fifth instruction;
executing each of the fourth instruction and the fifth instruction using a single-stage pipeline;
accessing memory for the fourth instruction and the fifth instruction before accessing memory for the first instruction; and
fetching the second instruction with a delay from the fetching of the first instruction such that memory access of the second instruction is conducted after the first instruction, wherein the fetch operation of the second instruction is started upon the lapse of one clock after the fetch operation of the instruction.

20. A method according to claim 19, wherein the delay is of at least three clocks.

21. A method according to claim 19, further comprising:
decoding the second instruction;
executing the second instruction by use of a single-stage pipeline such that memory access is performed immediately after the first instruction;
fetching the third instruction;
decoding the third instruction;
executing the third instruction; and
accessing memory.

22. A central processing unit (CPU) having a pipeline configuration that processes an instruction set comprising a plurality of instructions, comprising:
means for reading the instructions from a memory;
means for decoding the instructions;
means for executing a specified processing based on the instructions; and
means for writing a result of the specified processing into the memory,
wherein the instruction set comprises:
a first instruction;
a second instruction dependent upon the first instruction, wherein offset information is added to the second instruction, wherein the offset information specifies the distance between the second instruction and the first instruction; and
a third instruction dependent upon the first instruction, wherein offset information is added to the third instruction, wherein the offset information specifies the distance between the third instruction and the first instruction.

23. An instruction set, comprising:
an initial instruction;
a first instruction; and
a second instruction that depends upon the first instruction, wherein the second instruction includes offset information and a depended instruction,
wherein the offset information is stored until the depended instruction is reached.

24. An instruction set according to claim 23, further comprising:
a third instruction;
a fourth instruction having no dependency upon the first instruction; and
a fifth instruction having no dependency upon the first instruction.
